(19) United States
(12) Patent Application Publication
(10) Pub. No.: US 2020/0326537 A1
(43) Pub. Date: Oct. 15, 2020

(54) GESTURE CONTROL OF HEADS-UP DISPLAY

(71) Applicant: Hypergiant Industries, Inc., Austin, TX (US)

(72) Inventors: Andrew Thomas Busey, Austin, TX (US); Benjamin Edward Lamm, Dallas, TX (US); Daniel Haab, Austin, TX (US); Greg Amato, San Antonio, TX (US); Davis Saltzgiver, Austin, TX (US)

(21) Appl. No.: 16/748,469

(22) Filed: Jan. 21, 2020

Related U.S. Application Data
(60) Provisional application No. 62/832,872, filed on Apr. 11, 2019.

(51) Int. Cl. G02B 27/01; G02B 27/00; G06F 3/01

(52) U.S. Cl. CPC G02B 27/0101; G02B 27/0093; G02B 2027/014; G02B 2027/0138; G06F 3/017

(57) ABSTRACT

An apparatus for providing gesture recognition that may be used to control the display of data in a heads-up display (HUD) is disclosed. The HUD may be a HUD associated with a visor on a user's helmet or another aeronautical helmet. An image capture system (e.g., camera) coupled to the helmet (or spacesuit) may be used to capture images of gestures being made by the user. Recognition of the gestures may then be used to control the display of data in the HUD. Control of the display of data may include controlling the selection of data that is displayed or turning on/off the HUD display in an on-demand capacity.

### PRIORITY CLAIM

The present applications claims priority to U.S. Provisional Appl. No. 62/832,872, filed Apr. 11, 2019, the disclosure of which is incorporated by referenced herein in its entirety.

### BACKGROUND

### Technical Field

The present disclosure relates generally to systems and methods for providing gesture recognition in a user's field of view. More particularly, embodiments disclosed herein relate to wearable devices with heads-up displays that implement gesture recognition for control of the heads-up display.

### Description of Related Art

Enhanced helmet display requirements, for example, those promulgated by the National Aeronautics and Space Administration (NASA), have been imposed on the next generation of space suits suitable for extra-vehicular activity (EVA). Some non-limiting examples of the new requirements include full color graphical displays including continually updated procedures, checklists, photo imagery, and video. Current space suits that are suitable for extra-vehicular activity (EVA) generally utilize small one line, 12-character alpha-numeric display panels located on the external surface of the space suit, often in the chest or trunk area, and display a limited set of suit system data. While current display technology may satisfy the image-generating requirements of new space suit helmet displays, current head- and helmet-mounted display system designs are insufficient for the next generation spacesuit.

There are some current helmet or eye-wear mounted heads-up displays and augmented reality displays that enable users to view augmented reality data in detail. But currently available technologies are inadequate for use with a space suit helmet and other aeronautical-related helmets. For example, currently available systems rely on a marker-based system, which detects physical objects based on pre-defined rules. These systems typically use an optical square marker to identify physical-world objects (such as tables, floors, windows, etc.) and project or superimpose virtual objects over the identified real-world objects. These traditional marker-based systems perform adequately when the physical world matches the data that is pre-programmed into an augmented reality system. However, these systems often break down or become unreliable when new or unexpected physical environments are encountered for augmentation purposes, such as environments encountered in space.

There have been some attempts made to overcome the limitations of marker-based systems by introducing markerless augmentation systems. Markerless augmentation systems map virtual objects in a three-dimensional space that may be captured by various cameras and hardware. Markerless systems may, however, require additional hardware and significant additional processing power, which typically also increases the thermal heat generated by these devices. For example, markerless augmentation systems often require multiple digital cameras, infrared sensors, and GPS data in order to superimpose digital elements in an augmented reality space. Additionally, traditional markerless systems, because of the various processing constraints, cannot be used in an on-demand or always-on manner.

Thus, traditional marker-based and markerless systems may be inadequate for use in certain environments, such as aeronautical environments or space, where processing capabilities, freedom/ability to initiate the augmentation system, permissible thermal ranges, and traditional environment for pattern matching and detection of physical objects/environments are in short supply.

### BRIEF DESCRIPTION OF THE DRAWINGS

The following detailed description makes reference to the accompanying drawings, which are now briefly described.

FIG. 1 depicts a representation of an apparatus, according to some embodiments.

FIG. 2 depicts a representation of a visor as seen by a user (astronaut), according to some embodiments.

FIG. 3 depicts a block diagram of an apparatus, according to some embodiments.

FIG. 4 depicts a block diagram of a communication environment for an apparatus, according to some embodiments.

FIG. 5 is a block diagram of a system configured to provide gesture recognition for an apparatus, according to some embodiments.

FIG. 6 depicts a first example of a user's hand in motion that may be shown in images captured using an image capture system.

FIG. 7 depicts a second example of a user's hand in motion that may be shown in images captured using an image capture system.

FIG. 8 depicts a block diagram illustrating a training system configured to train a machine learning module, according to some embodiments.

FIG. 9 is a flow diagram illustrating a method for recognizing gestures based on images captured by an image capture device and controlling a display based on the recognized gestures, according to some embodiments.

FIG. 10 is a flow diagram illustrating a method for training a machine learning module to generate a predictive score for classifying a gesture, according to some embodiments.

FIG. 11 depicts a block diagram illustrating an example of a trained machine learning module system.

FIG. 12 is a block diagram of one embodiment of a computer system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that an element is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z). In some situations, the context of use of the term “or” may show that it is being used in an exclusive sense, e.g., where “select one of x, y, or z” means that only one of x, y, and z are selected in that example.

In the following description, numerous specific details are set forth to provide a thorough understanding of the disclosed embodiments. One having ordinary skill in the art, however, should recognize that aspects of disclosed embodiments might be practiced without these specific details. In some instances, well-known, structures, computer program instructions, and techniques have not been shown in detail to avoid obscuring the disclosed embodiments.

### DETAILED DESCRIPTION

The present disclosure is directed to a gesture recognition system for controlling the display of data in a heads-up display (HUD) positioned in a user's field of view on a helmet worn by the user. For example, the user may make gestures that are captured by an image capture system (camera) attached to a helmet or suit worn by the user. Examples of users that may wear a helmet and suit for implementation of gesture recognition include, but are not limited to, astronauts and aeronautical users. The gesture recognition system may recognize the gesture and then control the display of data (e.g., sensor data or other mission-related data) in the HUD. Using gesture recognition provides on-demand control of the display of data in the HUD. Gesture recognition may additionally be used for control and selection of other systems used by the user (such as devices coupled to the user's helmet or suit). For example, gesture recognition may be used to control movement of the user's visor (such as pivoting a visor screen in/out of the user's field of view), begin/end communications, turn cameras on/off, turn devices on/off, or control motion of the user.

Various other methods for control and selection of data for display in a HUD display have been contemplated. For example, voice control or user input device controls such as wrist-based controls, touchscreen control, and keypad controls may be implemented. Voice command controls or touch-based control methods may, however, be difficult or unreliable to implement in certain environments where discerning different sounds may be difficult (e.g., where sound may have to pass through barriers) or where controlling touch may be difficult (e.g., where equipment such as thick gloves makes touch unreliable or difficult). Examples of such environments include, but are not limited to space or aeronautical environments as well as other environments where voice command controls or touch-based control methods may be difficult to implement or unreliable. Control of the HUD display using gesture recognition may, to the contrary, provide quick and reliable control and selection of data for display in the HUD display.

In certain embodiments described herein, the gesture recognition is determined by analyzing two-dimensional images captured by the image capture system. Two-dimensional images may be captured using a single image capture device (e.g., a single camera). Using two-dimensional image capture instead of three-dimensional image capture for gesture recognition may reduce the thermal heat generated by the gesture recognition system by reducing the number of image capture devices needed. Adding significant additional thermal heat may be undesirable in space or aeronautical environments because suits for such environments have tight thermal ranges. Thus, adding additional heat sources to the system may require additional cooling to be provided, which may affect the life of the various battery packs that may be used to operate the suit. As such, gesture recognition based on capturing two-dimensional images using a single image capture device may be advantageous for space or aeronautical environments where heat generation is a viable concern.

Using two-dimensional image capture instead of three-dimensional image capture for gesture recognition may also reduce the processing power needed to provide gesture recognition. In space, battery life may be a critical need for prolonged activities away from a power source. Thus, there is a need to conserve power in operating a spacesuit. A low-power device may enable a user such as an astronaut to go on longer space walks or perform extra-vehicular tasks that are further from the power source. As such, gesture recognition based on capturing two-dimensional images using a single image capture device may be advantageous as using a single image capture device and processing two-dimensional images uses less power and processing power than using multiple image captured devices and processing three-dimensional images.

In some embodiments, gesture recognition described herein provides the capability for on-demand use and functionality. For example, gesture recognition described herein does not rely on the presence of a marker, which thus allows gesture recognition to initiate changes in the HUD on-demand or, in other words, as requested by the user. Providing on-demand control of the HUD may allow the user to conduct work as appropriate without taking an action that specifically requests additional information. Additionally, providing on-demand control of the HUD enables the heads-up display to remain turned off and out of the user's way when it is not required or necessary while allowing the HUD to be turned on when needed.

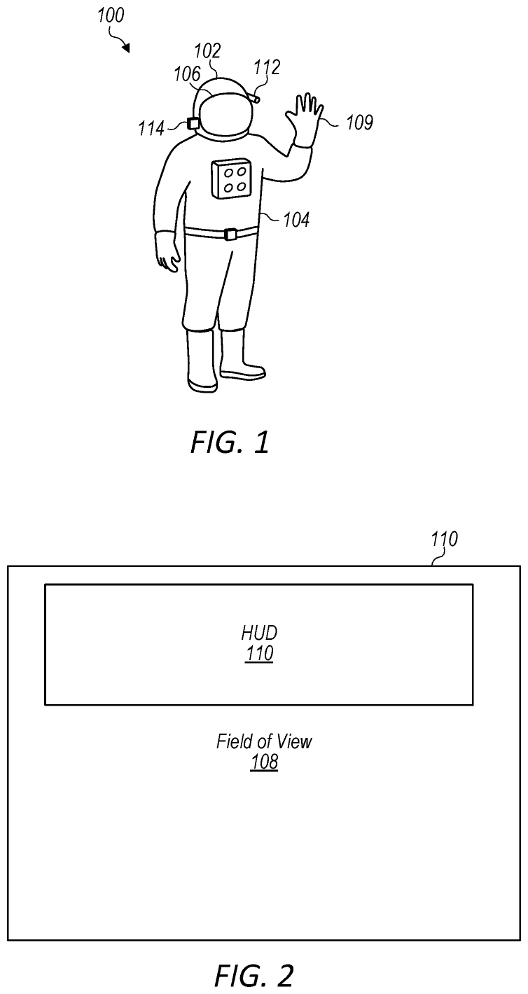

FIG. 1 depicts a representation of apparatus 100, according to some embodiments. Apparatus 100 may include one or more components that provide a gesture recognition system for the apparatus, as described herein. In certain embodiments, apparatus 100 includes wearable element 102. Wearable element 102 may be, for example, a helmet that that is attachable to spacesuit 104. Wearable element 102 and spacesuit 104 may be suitable for use in an aeronautical environment such as space. When attached, wearable element 102 and spacesuit 104 may provide a substantially sealed, breathable environment for the user (e.g., astronaut) inside apparatus 100. For example, wearable element 102 may provide a pressurized, oxygen-rich atmospheric bubble to protect the user's head when attached to spacesuit 104.

In certain embodiments, wearable element 102 includes visor 106. Visor 106 may be secured, attached, or coupled to wearable element 102 by any one of numerous known technologies. Visor 106 may provide a field of view for the user (e.g., astronaut) using apparatus 100. Visor 106 may include transparent portions or semi-transparent portions that permit the user to look outside of the helmet. The transparent or semi-transparent portions may also reduce certain wavelengths of light produced by glare and/or reflection from entering the user's eyes. One or more portions of the visor 106 may be interchangeable. For example, transparent portions may be interchangeable with semi-transparent portions. In some embodiments, visor 106 includes elements or portions that are pivotally attached to wearable element 102 to allow the visor elements to be raised and lowered from in front of the user's field of view.

FIG. 2 depicts a representation of visor 106 as seen by the user (e.g., astronaut) of apparatus 100, according to some embodiments. As shown in FIG. 2, visor 106 includes a display of field of view 108 for the user (e.g., the normal field of vision of the user through the visor). In certain embodiments, visor 106 includes display 110 in field of view 108. Display 110 may be, for example, a heads-up display (HUD) for presentation the user. In one embodiment, display 110 is a digital HUD. In certain embodiments, display 110 is a HUD that augments the user's field of view 108, as shown in FIG. 2. For example, display 110 provides additional information relevant to the user (such as vital system information). Data received from control module 404 may include such data as map data, mission objective data, additional image data, remote sensor data, or other remotely obtained data In some embodiments, display 110 is a HUD that takes up a substantial portion or replaces the user's field of view 108. For example, display 110 may provide the user an active replacement representation of field of view 108 based on images captured by an image capture device (camera) attached to wearable element 102 rather than the user's own view of field of view 108 through visor 106.

In certain embodiments, display 110 is implemented using any one of numerous known display devices suitable for rendering textual, graphic, and/or iconic information in a format viewable by the user. Non-limiting examples of such display devices include various light engine displays, organic electroluminescent display (OLED), and flat screen displays such as LCD (liquid crystal display) and TFT (thin film transistor) displays. In some embodiments, display 110 may be included in other display device(s) such as eyeglasses or goggles worn by the user inside apparatus 100 (e.g., wearable element 102 is eyeglasses or goggles worn by the user inside a helmet).

In certain embodiments, as shown in FIG. 1, apparatus 100 includes image capture system 112 coupled to wearable element 102. In some embodiments, image capture system 112 is coupled to a side of wearable element 102, as shown in FIG. 1. Image capture system 112 may, however, be coupled to wearable element 102 or spacesuit 104 at any position that provides the image capture system with a view directed towards the field of view of the user of the wearable element. For example, image capture system 112 may be coupled on the bottom of wearable element 102 or near the chest portion of spacesuit 104.

Image capture system 112 may capture images near or proximate to the user. In certain embodiments, image capture system 112 captures images in the field of view of the user. For example, images may be captured of hand 109 as the hand moves in/out of the field of view of the user. Image capture system 112 may include one or more cameras. In one embodiment, image capture system 112 includes a single camera. Examples of cameras that may be included in image capture system 112 include, but are not limited to, two-dimensional image cameras, motion capture cameras, optical (visual) cameras, infrared (IR) cameras, thermal imaging cameras (TICs), three-dimensional image cameras, night vision cameras, and electromagnetic spectrum imaging cameras.

In some embodiments, as shown in FIG. 1, apparatus 100 includes sensor array 114. Sensor array 114 may be coupled to wearable element 102 or spacesuit 200. In some embodiments, sensor array 114 may include elements or devices coupled to both wearable element 102 and spacesuit 200. In some embodiments, image capture element 112 is a part of sensor array 114. Sensor array 114 may include environmental sensor devices to measure properties external to apparatus 100 and suit status sensor devices to measure properties inside apparatus 100. Environmental sensor devices may include, but not be limited to, proximity sensors, ranging sensors, GPS sensors, position sensors, magnetic detection sensors, radiation sensors, chemical sensors, external temperature sensors, pressure sensors, humidity sensors, air quality sensors, and/or object detection sensors. Suit status sensor devices may include, but not be limited to, suit pressure sensors, suit temperature sensors, oxygen level sensors, battery level sensors, water level sensors, carbon dioxide level sensors, timing sensors (e.g., EVA timing), suit air quality sensors, and biometric sensors (such as vital sign measurement sensors, body motion sensors, and body position sensors).

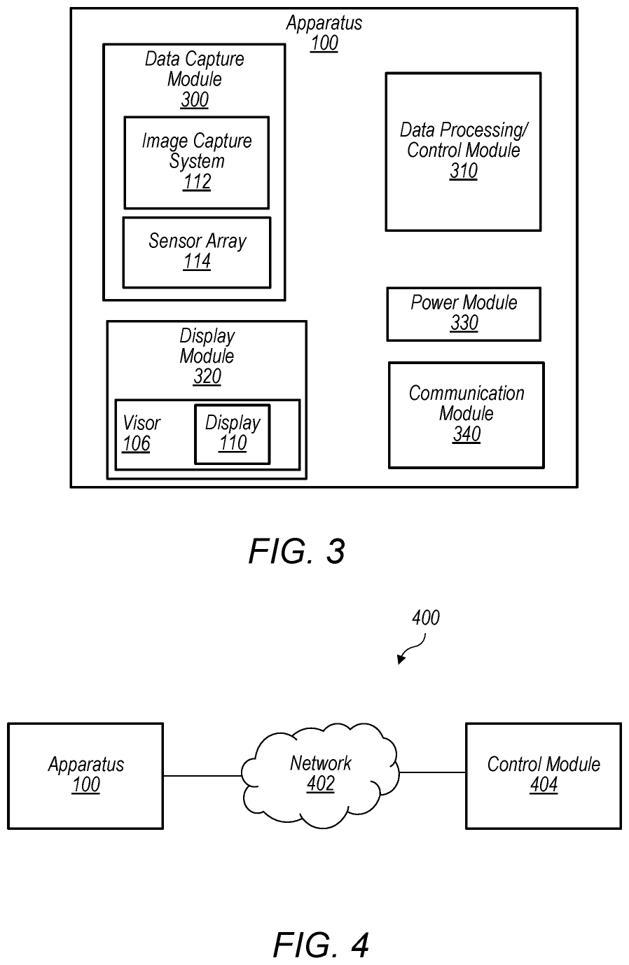

FIG. 3 depicts a block diagram of apparatus 100, according to some embodiments. In certain embodiments, apparatus 100 includes data capture module 300, data processing/control module 310, display module 320, power module 330, and communication module 340. Data capture module 300 may be coupled to and receive data from image capture system 112 and sensor array 114. Data capture module 300 may receive data from image capture system 112 and sensor array 114 using wired and/or wireless communication. In some embodiments, data capture module 300 receives data through communication module 340.

Data processing/control module 310 may include elements coupled to wearable element 102 or spacesuit 200. In some embodiments, data processing/control module 310 includes elements coupled to both wearable element 102 and spacesuit 200. Data processing/control module 310 may include elements that process data from a variety of sources in apparatus 100 and control or operate various systems of the apparatus. For example, data processing/control module 310 may process data from image capture system 112 and sensor array 114 and control operation of display 110 based on the processed data (e.g., provide commands for displaying processed data on the display). Data processing/control module 310 may be capable of receiving external data (e.g., data from communication system 340) and providing the data to systems (e.g., display 110) within wearable element 102. Data processing/control module 310 may further be capable of providing processed data to external/remote systems or modules (e.g., a command or control module as described herein) using communication module 340.

Display module 320 may include or be coupled to visor 106 and display 110. Display module 320 may be capable of receiving data from any of various systems or modules in apparatus 100 (e.g., data processing/control module 310) and operating to display the data on display 110 of visor 106. As mentioned above, display 110 may include display component(s) to provide a HUD display to a user/wearer of wearable element 102.

Power module 330 may include power supplies and/or other devices for providing power to the various systems in apparatus 100. For example, power module 330 may include one or more batteries for providing power to apparatus 100. The batteries may be, for example, rechargeable batteries that are charged using a charging port (e.g., USB charging port) or another connector type. In some embodiments, the batteries may be charged using solar panels in or on apparatus 100 or any other suitable charging means. In some embodiments, power module 330 may include batteries or other power sources located on wearable element 102 or spacesuit 104. For example, a battery or power source may be in a pack (e.g., battery pack) carried on a back of wearable element 102 or spacesuit 104.

Communication module 340 may operate to provide communication capabilities between various systems or modules in apparatus 100 (e.g., between data capture module 300, data processing/control module 310, and display module 320) as well as provide communication between the apparatus and external/remote systems (e.g., control module 404, described herein). Communication module 340 may utilize various wired and/or wireless communication protocols to provide communication within and external to apparatus 100. Wireless communication protocols for communication module 340 may include protocols such as, but not limited to, Bluetooth, Wi-Fi, ANT+, LiFi, and SATCOM. In some embodiments, communication module 340 may include optical communication devices (e.g., line-of-sight communication devices). Optical communication devices may be implemented, for example, in sensor array 114 to provide line-of-sight communication between additional apparatus deployed at a location or other communication stations.

FIG. 4 depicts a block diagram of communication environment 400 for apparatus 100, according to some embodiments. Communication environment 400 may include apparatus 100, network 402, and control module 404. Network 402 may be used to connect apparatus 100 and control module 404 along with additional systems or modules and computing devices that may be associated with the apparatus or control module. In certain embodiments, network 402 is an intranet, an extranet, a virtual private network (VPN), a local area network (LAN), a wireless LAN (WLAN), a wide area network (WAN), a metropolitan area network (MAN), a portion of the Internet, or another suitable network. In some embodiments, network 402 may include a combination of two or more such networks.

Control module 404 may be a remotely or centrally located control module. For example, control module 404 may be a base control module, a mission control module, a strategic control module, or another operational control module. Control module 404 may be located at any location relative to the deployment location of apparatus 100. For example, control module 404 may be located on a spaceship providing a base of operation for apparatus 100. Alternatively, control module 404 may be located at a remote command center such as mission control back on Earth while apparatus 100 is in space.

In certain embodiments, apparatus 100, as described herein, is capable of collecting data related to the user's environment (e.g., data from image capture system 112 and sensor array 114 and/or external data related to the environment received from control module 404), processing the data, and generating a display presented to the user on display 110 (e.g., the HUD display for the user as described herein). Examples of data that may be displayed on display 110 include, but are not limited to, image data from image capture system 112, sensor data from sensor array 114 (as described above), and data received from control module 404. Data received from control module 404 may include such data as map data, mission objective data, additional image data, remote sensor data, or other remotely obtained data.

In certain embodiments, data/information displayed in display 110 on visor 106, shown in FIG. 2, is selectively controlled (e.g., switched) by the user (e.g., the wearer of apparatus 100). For example, the user may select or control the data displayed in display 110, how the data is displayed in the display, the position of display in field of view 108, turn on/off display 110, or other user selectable control of the display. In some embodiments, control and selection of data for display in display 110 by the user allows the user to add/remove data from the vision of the user as needed or desired based on the current activity of the user. Allowing the user to control the selection of data displayed in display 110 may allow the user to efficiently operate by limiting the data displayed to necessary information for the immediate task. In some embodiments, display 110 displays information on-demand. For example, display 110 may not have to always display information on the display and information may be displayed on-demand based on user's gesture control of the display. Providing on-demand display of information may allow a user (e.g., an astronaut) to perform tasks with high visibility of the environment around the user while the user's vision is only temporarily partially occluded by data in display 110.

In certain embodiments, gesture recognition in apparatus 100 is used for control and selection of data for display in display 110. For example, apparatus 100 may be programmed to capture gestures using image capture system 112 and recognize certain gestures by the user's hand in the captured images to control and select operations of display 110. Controlling and selecting operations of display 110 may include controlling and selecting operations such as allowing the user to switch/scroll between data for different devices/equipment being displayed on the display by using gestures. Gesture recognition may additionally be used for control and selection of devices operating on apparatus 100. For example, gesture recognition may be used to control movement of different portions of visor (such as pivoting a visor screen in/out of the user's field of view), begin/end communications, turn cameras on/off, turn jet packs on/off or steer jet packs, etc. Control using gesture recognition may provide quick and reliable control and selection of data for display in display 110 when apparatus 100 is used in environments, such as space or aeronautical environments, that make other types of control methods difficult or unreliable to implement (such as voice control or touch-based controls).

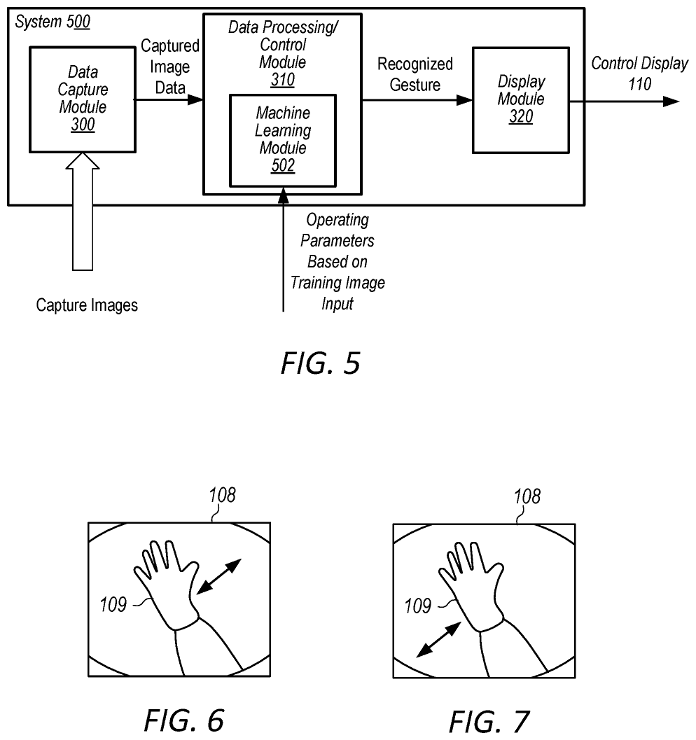

FIG. 5 is a block diagram of a system configured to provide gesture recognition for apparatus 100, according to some embodiments. System 500 includes data capture module 300, data processing/control module 310, and display module 320, which are described above for apparatus 100. Data capture module 300, data processing/control module 310, and display module 320, as described herein, may be implemented as computer-executable instructions and can operate to provide gesture recognition in apparatus 100.

Data capture module 300, data processing/control module 310, and display module 320 may operate to provide gesture recognition and control of display 110 or apparatus 100 based on the recognized gesture. In certain embodiments, as shown in FIG. 5, images are captured by data capture system 300 using image capture system 112. As described above, image capture system 112 may be directed at the user's field of view such that the captured images may show the user/astronaut's hand when the user places the hand in the field of view. While the user's hand is in the field of view, the user may make a motion with the hand that can be recognized as a gesture by system 500.

In certain embodiments, data capture module 300 is continuously (or substantially continuously) capturing images of the user's field of view. Thus, when the user's places the hand in the field of view, the captured images may include a series or sequence of images, or a series or sequence of frames captured as video, that show motion of the hand of the user. The series or sequence of images captured by data capture module 300 may be assessed by data processing/control module 310 to determine whether the motion of the user's hand is recognized as a gesture in the images (as described below).

FIGS. 6 and 7 depict examples of a user's hand in motion that may be shown in images captured using image capture system 112. The arrows in FIG. 6 represent an embodiment of motion upwards by the user's hand that may be shown in images captured by image capture system 112. The arrows in FIG. 7 represent an embodiment of motion downwards by the user's hand that may be shown in images captured by image capture system 112. While FIGS. 6 and 7 depict examples of upwards and downwards motion of the user's hand, it is to be understood that the motion by the user's hand may include any number of different gestures using the hand, arm, fingers, or thumb in the field of view. For example, the user may make circular motions with the hand, make a gesture with one or more fingers or the thumb, display a certain number of fingers, or display a combination of different number of fingers.

As shown in FIG. 5, data capture module 300 may provide captured image data to data processing/control module 310. Data processing/control module 310 may assess (e.g., analyze) the captured images to determine whether the hand motion (e.g., a motion such as shown in FIG. 6 or 7) is recognized as a gesture known by the data processing/control module (e.g., determine whether the gesture in the captured images is recognized as a predetermined gesture). For example, data processing/control module 310 may determine a first gesture being made by the user's hand for images corresponding to the hand motion in FIG. 6 or a second gesture being made by the user's hand for images corresponding to the hand motion in FIG. 7. In certain embodiments, the images are assessed for motion of the user's hand as the images are being captured by data capture module 300. For example, images may be continuously provided to data processing/control module 310 as the images are captured. Data processing/control module 310 may continuously (or substantially continuously) assess the received images for recognized gestures by the user. For example, data processing/control module 310 may assess an image for a gesture by the user once the image is captured and by continually assessing successive images as the images are captured. In some embodiments, data processing/control module 310 may assess motion of the user's hand by comparison of a current image to previously captured images (e.g., images captured immediately preceding the current image) for changes in position of the user's hand, fingers, or thumb.

In certain embodiments, data processing/control module 310 implements machine learning module 502 to recognize the gesture made by the user in the captured images. In some embodiments, machine learning module 502 is trained, as described herein, to recognize a gesture from captured images and output the recognized gesture. The recognized gesture determined by data processing/control module 310 may be provided to display module 320. Display module 320 may control display 110 based on recognition of the hand motion/gesture in the images as being a predetermined gesture. The predetermined gesture may correspond to a predetermined control for display 110. Predetermined controls for display 110 may include, but not be limited to, control of data displayed in display 110 (e.g., switching or scrolling of data displayed), control of how data is displayed in the display (e.g., color, brightness, transparency, etc.), control of position of display in field of view 108, or control of turning on/off the display, as described above.

As described above, in certain embodiments, data processing/control module 310 implements machine learning module 502 to recognize the gesture made by the user in the captured images. Machine learning module 502 may include any combination of hardware or software (e.g., program instructions) located in a computing system. Machine learning module 502 may be, for example, a neural network module or a computer vision module. In certain embodiments, machine learning module 502 implements one or more image-based learning algorithms (e.g., a computer vision algorithm).

In certain embodiments, machine learning module 502 is a trained machine learning module where the machine learning module has been trained to classify input images to recognize gestures in the images. Machine learning module 502 may include machine learning circuitry installed or configured with operating parameters that have been learned by the machine learning module itself or a similar machine learning module (e.g., a machine learning module operating on a different processor or device). For example, machine learning module 502 may be trained using training data (e.g., reference data) to generate operating parameters for the machine learning circuitry. The operating parameters generated from the training may then be used to operate machine learning module 502 (or used on another similar machine learning module).

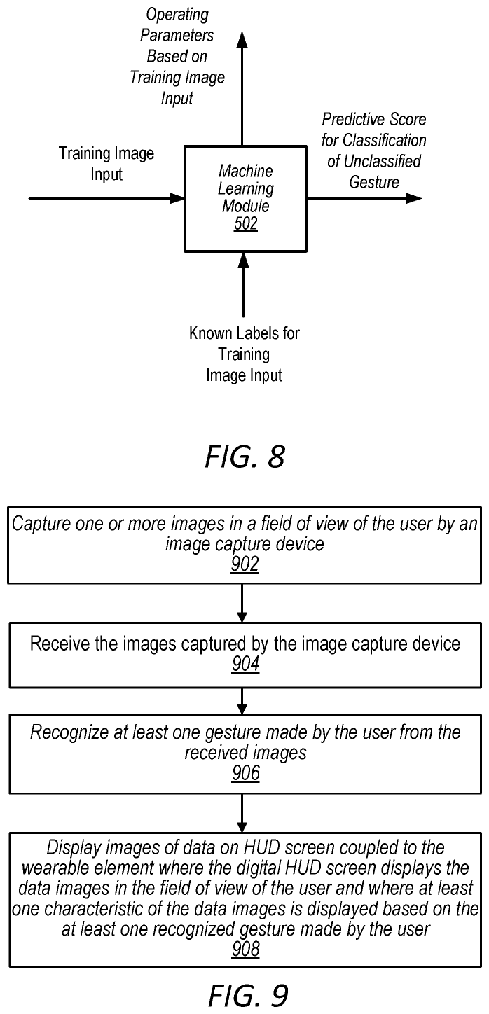

FIG. 8 depicts a block diagram illustrating a training system configured to train machine learning module 502, according to some embodiments. Training system 800 may include providing training image input to machine learning module 502. The training image input may include a variety of gestures in the image input to train machine learning module 502 to recognize different gestures. The various gestures in the training image input may be provided in a variety of different image input types including, but not limited to, still images, animated images, series of images, and videos. In certain embodiments, the training image input is provided as two-dimensional data (e.g., the images or videos are two-dimensional images). The gestures in the training image input may correspond to one or more classification categories associated with machine learning module 502. The classification categories may include, for example, categories of predetermined gestures to be recognized by machine learning module 502.

Known labels for the training image input may be provided to machine learning module 502 along with the training image input. The known labels may include labels of known information (e.g., known gestures, hand positions, or hand orientations) that correspond to one or more subsets of the training image input. Thus, for a particular training image input (e.g., images with a particular gesture), the known labels include labels selected based on the information that machine learning module 502 is attempting to predict (e.g., the predictive score for a gesture, described below, that the machine learning module is attempting to recognize). For example, for apparatus 100, machine learning module 502 may be trained to recognize a gesture made by a user's hand in the user's field of view. In some embodiments, known labels are provided as augmented information on training image input.

Based on the input of the training image input and the known labels, machine learning module 502 can be trained to generate a predictive score for gesture recognition based on two-dimensional image data. Gesture recognition may include determining whether a user's hand is present and whether the hand is in one of the classification categories (e.g., categories of predetermined gestures) based on the training image input. The predictive score may be a score that indicates whether an unclassified gesture corresponds to at least one of the classification categories associated with machine learning module 502. In some embodiments, the predictive score is a probability that the unclassified gesture corresponds to at least one of the classification categories associated with machine learning module 502 (e.g. a score ranging from 0-100 or some other range). In some embodiments, the predictive score may be a binary decision (e.g., yes/no) that the unclassified item corresponds to at least one of the classification categories associated with machine learning module 502.

In some embodiments, training of machine learning module 502 includes optimization of operating parameters (e.g. classifiers) used in the machine learning module to generate the predictive score. For example, a score may be provided on the known labels input into machine learning module 502. Machine learning module 502 may then be optimized by determining operating parameters that generate a predictive score that is as close to the score input on the known labels as possible. The operating parameters for the training image input may then be used to operate machine learning module 502 for recognizing gestures based on two-dimensional image data, as shown in FIG. 5.

In some embodiments, training machine learning module 502 to recognize gestures based on three-dimensional image data may be possible. Training and implementing gesture recognition based on three-dimensional image data, however, uses multiple cameras and/or depth sensing cameras to capture images and thus it may be less energy efficient and more difficult to control thermal ranges on apparatus 100 than using a single camera capturing two-dimensional images. Thus, in environments where energy efficiency and controlling thermal range are of importance, such as in space or aeronautical environments, training and implementing gesture recognition based on two-dimensional image data may be advantageous. Training and implementing gesture recognition based on two-dimensional image data may also allow a gesture made by a user to be recognized without a reference marker (such as a pivot point or skeletal marker) and without receiving image data from an additional image capture device (as only a single image capture device is needed to capture two-dimensional images).

### Example Methods

FIG. 9 is a flow diagram illustrating a method for recognizing gestures based on images captured by an image capture device and controlling a display based on the recognized gestures, according to some embodiments. The method shown in FIG. 9 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In various embodiments, some or all elements of this method may be performed by a particular computer system.

At 902, in the illustrated embodiment, one or more images in a field of view of the user are captured by an image capture device coupled to a wearable element worn by a user. The wearable element may be a helmet apparatus attached to a spacesuit. In some embodiments, the captured images are two-dimensional images.

At 904, in the illustrated embodiment, a computer system coupled to the wearable element receives the images captured by the image capture device.

At 906, in the illustrated embodiment, the computer system recognizes, from the received images, at least one gesture made by the user. In some embodiments, recognizing the at least one gesture made by the user includes classifying the at least one gesture into a gesture classification category. In some embodiments, classification of the at least one gesture in the received images is implemented using one or more trained machine learning algorithms. In some embodiments, the at least one gesture made by the user is recognized without a reference marker and without receiving image data from an additional image capture device.

At 908, in the illustrated embodiment, images of data are displayed on a digital heads-up display (HUD) screen coupled to the wearable element where the digital HUD screen displays the data images in the field of view of the user and where at least one characteristic of the data images is displayed based on the at least one recognized gesture made by the user. In some embodiments, the at least one characteristic of the data images includes data for a device coupled to the wearable element. In some embodiments, the at least one characteristic of the data images includes a selection of data for display on the digital HUD screen.

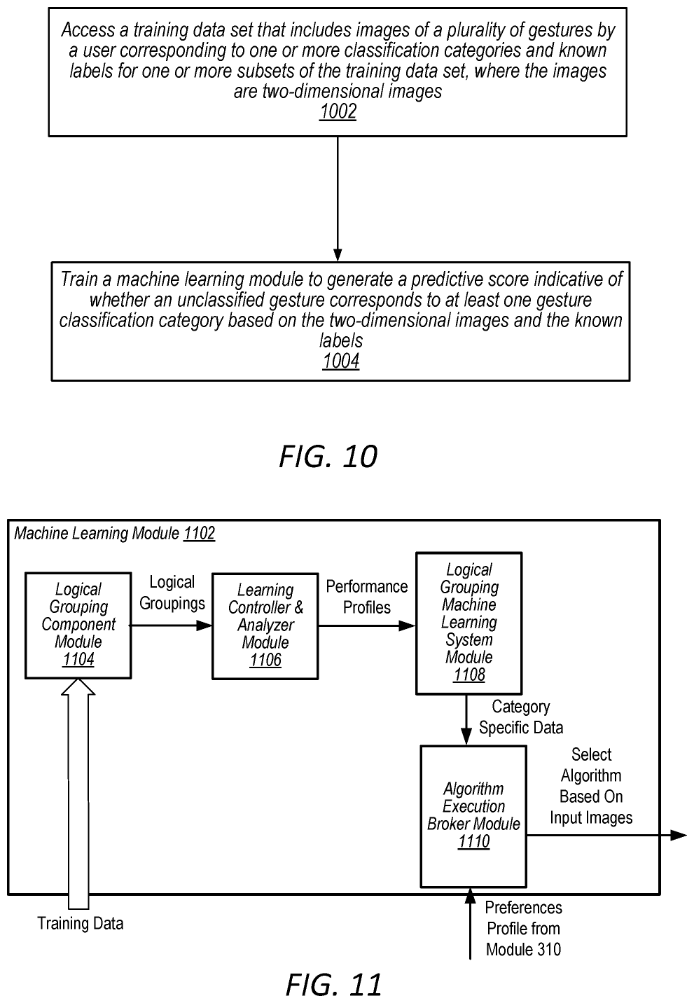

FIG. 10 is a flow diagram illustrating a method for training a machine learning module to generate a predictive score for classifying a gesture, according to some embodiments. The method shown in FIG. 10 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In various embodiments, some or all elements of this method may be performed by a particular computer system.

At 1002, in the illustrated embodiment, a computer system accesses a training data set that includes images of a plurality of gestures by a user corresponding to one or more classification categories and known labels for one or more subsets of the training data set, where the images are two-dimensional images.

At 1004, in the illustrated embodiment, the computer system trains a machine learning module to generate a predictive score indicative of whether an unclassified gesture corresponds to at least one gesture classification category based on the two-dimensional images and the known labels. In some embodiments, the machine learning module is a computer vision module. In some embodiments, training the machine learning module includes determining one or more classifiers for implementation in the machine learning module. In some embodiments, training the machine learning module includes training the machine learning module to recognize a gesture without a reference marker and without receiving image data in addition to the two-dimensional images.

### Example of Trained Machine Learning Module

FIG. 11 depicts a block diagram illustrating an example of a trained machine learning module system. Machine learning module 1102 may create a generalized performance profile for various logical groupings. Machine learning module 1102 may receive the performance profiles as training data and be trained to maximize the ability of the system to produce high confidence gesture recognition while minimizing the required resources. Training of machine learning module 1102 may be used to produce a machine learning module that recognizes (e.g., by classification), in real time, input image data from an image capture system (such as image capture system 112) to dynamically determine whether a gesture performed by a user is a recognized gesture.

In some embodiments, machine learning module 1102 includes logical grouping component module 1104, learning controller and analyzer module 1106, logical grouping machine learning system module 1108, and algorithm execution broker module 1110. Logical grouping component module 1104 may break the training data (e.g., training image input) into groupings based on computer vision analysis and masks that may be applied to the training data.

In a training phase, machine learning module 1102 receives training data with associated context and predetermined logical groupings and uses algorithms to find gestures based on the training data. In the training phase, learning controller and analyzer module 1106 receives the logical groupings, the algorithms run as part of the pipeline, and their output values, and how much influence the outputs of the algorithms contributed to the final determination. Learning controller and analyzer module 1106 may keep track of the system resource performance. For example, learning controller and analyzer module 1106 may record how long an algorithm runs and how much heap/memory is used by each algorithm. Learning controller and analyzer module 1106 receives the output information, algorithm, time taken, system resources, and number of input data items to the algorithm and creates a performance profile for that algorithm and logical grouping.

The performance characteristics used in metrics include heap sizes, CPU utilization, memory usage, the execution time of an algorithm, file input and output access and write speeds. Typical performance characteristics in a computing environment include the number of features produced by the algorithm and the number of data structures of a specific type that is currently loaded in memory. The correctness metrics include how many features for each algorithm were produced for that logical grouping and how those features for that logical grouping impact the overall result or the algorithm itself. Finally, correctness metrics may take into account, when a final answer is given, whether that answer is correct and how the features and algorithms affected the answer by weight.

In some embodiments, the algorithms may be modified or enhanced to output the data it operates on and what inputs contributed to its output. Some algorithms may use as input data that is provided as output by another algorithm. These algorithms may be used in various combinations and these combinations may contribute to the answer to varying degrees.

In the training phase, logical grouping machine learning system module 1108 receives the performance profiles as training data. Logical grouping machine learning system module 1108 receives as input the logical groupings, image context, and results of the answers. Logical grouping machine learning system module 1108 makes correlations between algorithms and logical groupings to provide category-specific data. The correlation and performance profiles represent a machine learning model that can be used to intelligently select algorithms to run for a given question.

The logical grouping machine learning system module 1108 uses intelligence techniques including machine learning models, such as, but not limited to, Logistical Regression. In one embodiment, the classifiers or input for the machine learning models can include the features and performance metrics produced by the algorithms for a logical grouping.

Algorithm execution broker module 1110 uses the machine learning model and the classification of the question and context in a logical grouping to determine which algorithms to run in real time. Based on the logical grouping and performance requirement, the algorithm execution broker module 1110 dynamically controls which algorithms are run and the resources necessary using the machine learning model.

In accordance with some embodiments, machine learning module 1102 receives a preferences profile, which defines preferences of data processing/control module 310 described herein. Preferences profile may define performance requirements, system resource restrictions, and desired accuracy of answers. Machine learning module 1102, more particularly algorithm execution broker module 1110, selects algorithms to use for a given set of images based on preferences profile, meeting the performance requirements and system resource utilization restrictions of the system.

The components of machine learning module 1102 may work in tandem to allow for a more efficient and performance generalized gesture detection system. As machine learning module 1102 is built and updated, the logical grouping of questions and context can be more defined and sub-categorized, which may produce a better deep question and answering system.

Logical grouping component module 1104 may break the question down into key areas or groups based on the subject and the context domain. Logical grouping component module 1104 may use any additional context information to conform and further group the question. For well-known or easy to identify gestures, these can be matched against predefined broad groups with smaller groups.

Learning controller and analyzer module 1106 may perform algorithm data capture, analyze system performance, and perform logical grouping association. The algorithms may identify themselves as they run and provide as output the feature set they are interested in. Learning controller and analyzer module 1106 may assign a weight to each algorithm based on how much each feature affected the results. Weights may be on any unified scale, such as zero to one, zero to ten, or zero to one hundred. Each algorithm may have a unified application programming interface (API) to provide weight data. Algorithms may provide as output how many features are added and which features are added or modified.

Learning controller and analyzer module 1106 may monitor heap size and memory pools. Learning controller and analyzer module 1106 may also capture start and end time for algorithm execution. Learning controller and analyzer module 1106 may also record the number of relevant features in the common analysis structure (CAS) and the number of CASes in the overall system. The common analysis structure in this embodiment can be generally substituted by a common data structure that is used within the overall system.

Logical grouping machine learning system module 1108 may capture the logical groupings that affect the analyzer and uses the captured groupings to make correlations between groupings and algorithms that contribute to accurate results. Based on these correlations, logical grouping machine learning system module 1108 may decide among multiple candidate groupings and multiple candidate sets of algorithms.

Algorithm execution broker module 1110 may select a set of algorithms for a given question based on the feature types and features in a CAS and based on the influence level with which these features impact the algorithm. Algorithm execution broker module 1110 may apply the learning model to the incoming data and, if over a predetermined or dynamically determined threshold of influence, sets a given algorithm to execute.

### Example Computer System

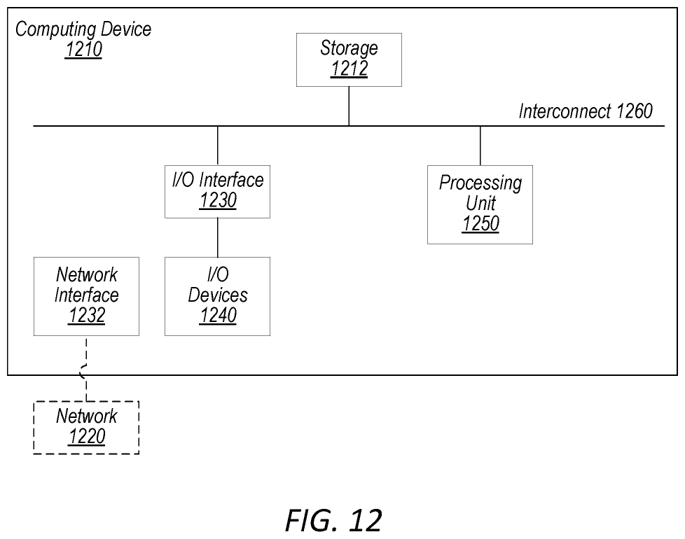

Turning now to FIG. 12, a block diagram of one embodiment of computing device (which may also be referred to as a computing system) 1210 is depicted. Computing device 1210 may be used to implement various portions of this disclosure. Computing device 1210 may be any suitable type of device, including, but not limited to, a personal computer system, desktop computer, laptop or notebook computer, mainframe computer system, web server, workstation, or network computer. As shown, computing device 1210 includes processing unit 1250, storage subsystem 1212, and input/output (I/O) interface 1230 coupled via an interconnect 1260 (e.g., a system bus). I/O interface 1230 may be coupled to one or more I/O devices 1240. Computing device 1210 further includes network interface 1232, which may be coupled to network 1220 for communications with, for example, other computing devices.

In various embodiments, processing unit 1250 includes one or more processors. In some embodiments, processing unit 1250 includes one or more coprocessor units. In some embodiments, multiple instances of processing unit 1250 may be coupled to interconnect 1260. Processing unit 1250 (or each processor within 1250) may contain a cache or other form of on-board memory. In some embodiments, processing unit 1250 may be implemented as a general-purpose processing unit, and in other embodiments it may be implemented as a special purpose processing unit (e.g., an ASIC). In general, computing device 1210 is not limited to any particular type of processing unit or processor subsystem.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Storage subsystem 1212 is usable by processing unit 1250 (e.g., to store instructions executable by and data used by processing unit 1250). Storage subsystem 1212 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on. Storage subsystem 1212 may consist solely of volatile memory, in one embodiment. Storage subsystem 1212 may store program instructions executable by computing device 1210 using processing unit 1250, including program instructions executable to cause computing device 1210 to implement the various techniques disclosed herein.

I/O interface 1230 may represent one or more interfaces and may be any of various types of interfaces configured to couple to and communicate with other devices, according to various embodiments. In one embodiment, I/O interface 1230 is a bridge chip from a front-side to one or more back-side buses. I/O interface 1230 may be coupled to one or more I/O devices 1240 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus comprising:
a wearable element configured to be worn by a user;
an image capture device coupled to the wearable element, wherein the image capture device is configured to capture one or more two-dimensional images in a field of view of the user;
a digital heads-up display (HUD) screen coupled to the wearable element, wherein the digital HUD screen is positioned to display images of data in the field of view of the user; and
a processor circuit that includes one or more processing cores;
memory storing program instructions executable by the processor circuit to:
receive a plurality of two-dimensional images captured by the image capture device; and
recognize, based on at least one trained machine learning algorithm, gestures made by the user in the received two-dimensional images.

2. The apparatus of claim 1, wherein the program instructions executable by the processor circuit include instructions to control at least one characteristic in the digital HUD screen based on a recognized gesture made by the user.

3. The apparatus of claim 2, wherein the at least one characteristic in the digital HUD screen includes a characteristic related to the images of data displayed in the field of view of the user.

4. The apparatus of claim 1, wherein at least one image of data displayed in the field of view of the user includes data from a sensor positioned on the apparatus.

5. The apparatus of claim 1, wherein the image capture device is a single image capture device.

6. The apparatus of claim 1, wherein the image capture device is a single image capture device, and wherein the program instructions executable by the processor circuit include instructions to:
recognize, based on the at least one trained machine learning algorithm, at least one gesture made by the user by assessing motion of a hand of the user in the received two-dimensional images; and
control at least one characteristic in the digital HUD screen based on the at least one recognized gesture made by the user.

7. The apparatus of claim 1, wherein the wearable element is a helmet apparatus configured to be attached to a spacesuit.

8. The apparatus of claim 7, wherein the helmet apparatus and the spacesuit, when attached, provide a substantially sealed, breathable environment for the user inside the helmet apparatus and the spacesuit.

9. The apparatus of claim 1, wherein the image capture device includes an optical camera.

10. A non-transitory computer-readable medium having instructions stored thereon that are executable by a computing device to perform operations comprising:
capturing, by an image capture device coupled to a wearable element worn by a user, one or more two-dimensional images in a field of view of the user;
receiving, by a computer system coupled to the wearable element, the two-dimensional images captured by the image capture device;
assessing the received two-dimensional images, based on at least one trained machine learning algorithm, to recognize at least one gesture made by the user; and
displaying, on a digital heads-up display (HUD) screen coupled to the wearable element, images of data, wherein the digital HUD screen displays the images of data in the field of view of the user, and wherein at least one characteristic of the images of data is displayed based on the at least one recognized gesture made by the user.

11. The non-transitory computer-readable medium of claim 10, wherein assessing the received two-dimensional images includes assessing motion of a hand of the user in the received two-dimensional images.

12. The non-transitory computer-readable medium of claim 10, wherein the at least one characteristic of the images of data includes data for a device coupled to the wearable element.

13. The non-transitory computer-readable medium of claim 10, wherein the at least one characteristic of the images of data includes a selection of data for display on the digital HUD screen.

14. The non-transitory computer-readable medium of claim 10, wherein recognizing the at least one gesture made by the user includes classifying the at least one gesture into a gesture classification category.

15. The non-transitory computer-readable medium of claim 10, wherein assessing the received two-dimensional images is implemented substantially continuously.

16. The non-transitory computer-readable medium of claim 10, wherein the at least one trained machine learning algorithm is trained by:
accessing a training data set that includes images of a plurality of gestures by a user corresponding to one or more classification categories and known labels for one or more subsets of the training data set, wherein the images are two-dimensional images; and
training the machine learning algorithm to generate a predictive score indicative of whether an unclassified gesture corresponds to at least one gesture classification category based on the two-dimensional images and the known labels.

17. A method, comprising:
accessing a training data set that includes images of a plurality of gestures by a user corresponding to one or more classification categories and known labels for one or more subsets of the training data set, wherein the images are two-dimensional images; and
training a machine learning module to generate a predictive score indicative of whether an unclassified gesture corresponds to at least one gesture classification category based on the two-dimensional images and the known labels.

18. The method of claim 17, wherein training the machine learning module includes determining one or more classifiers for implementation in the machine learning module.

19. The method of claim 18, further comprising:
implementing the classifiers into a memory associated with a processor circuit that includes one or more processing cores, wherein the processor circuit is configured to be coupled to an apparatus comprising:
a wearable element configured to be worn by a user;
an image capture device coupled to the wearable element, wherein the image capture device is configured to capture one or more images in a field of view of the user; and
a digital heads-up display (HUD) screen coupled to the wearable element, wherein the digital HUD screen is positioned to display images of data in the field of view of the user;
wherein the memory stores program instructions executable by the processor circuit to:
receive images captured by the image capture device; and
recognize, from the received images, gestures made by the user based on the classifiers.

20. The method of claim 17, wherein the predictive score is a probability that the unclassified gesture corresponds to the at least one gesture classification category.
